(19) United States
(12) Patent Application Publication
(10) Pub. No.: US 2014/0101600 A1
(43) Pub. Date: Apr. 10, 2014

(54) PRESENTATION OF RELATED TASKS FOR IDENTIFIED ENTITIES

(71) Applicant: MICROSOFT CORPORATION, Redmond, WA (US)

(72) Inventors: Steve Macbeth, Redmond, WA (US); Lawrence Brian Ripsher, Seattle, WA (US); Severan Sylvain Jean-Michel Rault, Redmond, WA (US); Gary Voronel, Seattle, WA (US)

(73) Assignee: MICROSOFT CORPORATION, Redmond, WA (US)

(21) Appl. No.: 13/648,999

(22) Filed: Oct. 10, 2012

(51) Int. Cl. G06F 3/048

(52) U.S. Cl. 715/780; 715/764; 715/843

(57) ABSTRACT

Users are provided with information regarding entities and tasks that are associated with the user's current context, which includes the content currently being presented to the user. Services associated with a search engine database identify entities and associated tasks. A user's context is utilized to identify one or more entities and one or more associated tasks that may be relevant to the user's current context. Entities and tasks are presented through a dedicated menu, icon, or other like dedicated user interface element to which the user can direct action. Also, entities and tasks are presented through a separate user interface context, such as a separate screen. A user's context can also include information regarding future content that will be presented to the user. Then, entities and tasks are presented via the same user interface mechanisms used to request such content, such as textual input user interface mechanisms.

### BACKGROUND

As network communications among multiple computing devices have become ubiquitous, the quantity of information available via such network communications has increased exponentially. For example, the ubiquitous Internet and World Wide Web comprise information sourced by a vast array of entities throughout the world, including corporations, universities, individuals and the like. Such information is often marked, or “tagged”, in such a manner that it can be found, identified and indexed by services known as “search engines”. Even information that is not optimized for search engine indexing can still be located by services, associated with search engines, which seek out information available through network communications with other computing devices and enable a search engine to index such information for subsequent retrieval.

Due to the sheer volume of information available to computing devices through network communications with other computing devices, users increasingly turn to search engines to find the information they seek. Search engines typically enable users to search for any topic and receive, from this vast volume of information, identifications of specific information that is responsive to, or associated with, the users' queries, often presented in order of relevance or importance to the user. To sort through the vast amounts of information that is available, and timely provide useful responses to users' queries, search engines employ a myriad of mechanisms to optimize the identification and retrieval of responsive and associated information.

Unfortunately, search engines are, by definition, reactive entities in that they only provide information in response to an initial action seeking such information in the first place. Simply put, if a user does not realize that they are lacking specific information that may be of benefit to them, then all of the information that is available through the search engine will remain unused by such a user, and, thereby will not be of any benefit to that user.

### SUMMARY

In one embodiment, application programs presenting content to users can also provide an identification of entities that are associated with such content, an identification of tasks associated with those entities, or combinations thereof. In such a manner, application programs can enable users to efficiently perform tasks that such users were likely interested in performing, and can enable users to efficiently obtain information regarding entities that such users were also likely interested in.

In another embodiment, the presentation of associated entity and task information can be through a dedicated menu, icon, or other like dedicated user interface element to which a user can direct action when the user seeks the information presented by such an element.

In a further embodiment, the presentation of associated entity and task information can be through a separate screen, or other like separate user interface context, which the user can invoke when the user seeks the information presented in such a separate user interface context.

In a still further embodiment, entities and associated tasks can be selected for presentation not only based on a user's current context, such as the information currently being presented to the user, but can also be based on information the user is requesting for subsequent presentation. In such an embodiment, identifications of entities and tasks can be provided to the user through the user input mechanisms that the user is utilizing to request information for subsequent presentation such as, for example, textual input user interface mechanisms.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary network of computing devices exchanging communications for identifying entities and related tasks;

FIG. 2 is a block diagram of exemplary user interfaces presenting entity and task information;

FIG. 3 is a block diagram of further exemplary user interfaces presenting entity and task information;

FIG. 4 is a flow diagram of an exemplary operation of an application program receiving and presenting identified entities and related tasks; and

FIG. 5 is a block diagram of an exemplary computing device.

### DETAILED DESCRIPTION

The following descriptions are directed to user interfaces and associated mechanisms through which a user can be provided with information regarding entities and tasks that are associated with the user's current context, which includes the content currently being presented to a user. Services associated with a search engine database can identify entities and associated tasks. A user's context, such as the content currently being presented to a user, content previously presented to the user, and other information about the user, can be utilized to identify one or more entities and one or more associated tasks that may be relevant to the user's current context. Entities and tasks that are associated with the user's current context can be presented to such a user through a dedicated menu, icon, or other like dedicated user interface elements to which the user can direct action when the user desires to receive information regarding such entities and tasks. Alternatively, or in addition, entities and tasks can be presented to a user through a separate user interface context, such as a separate screen, which the user can invoke when the user desires to receive entity and task information. A user's context can also include information regarding future content that will be presented to the user, such as content the user has requested, or is in the process of requesting. In such an instance, entities and tasks associated with the user context including such content that will be presented to the user in the future, can be presented to the user via the same user interface mechanisms that the user is utilizing to request such content, such as, for example, textual input user interface mechanisms.

For purposes of illustration, the techniques described herein make reference to existing and known application user interface contexts, such as user interfaces typically presented by Web browsers. Also for purposes of illustration, the techniques described herein make reference to existing and known protocols and languages, such as the ubiquitous HyperText Transfer Protocol (HTTP) and the equally ubiquitous HyperText Markup Language (HTML). Such references, however, are strictly exemplary and are not intended to limit the mechanisms described to the specific examples provided. Indeed, the techniques described are applicable to any application user interface including, for example, lifestyle and/or entertainment applications, such as audio and/or video presentation applications and electronic book readers, and other content consuming and presentation applications.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

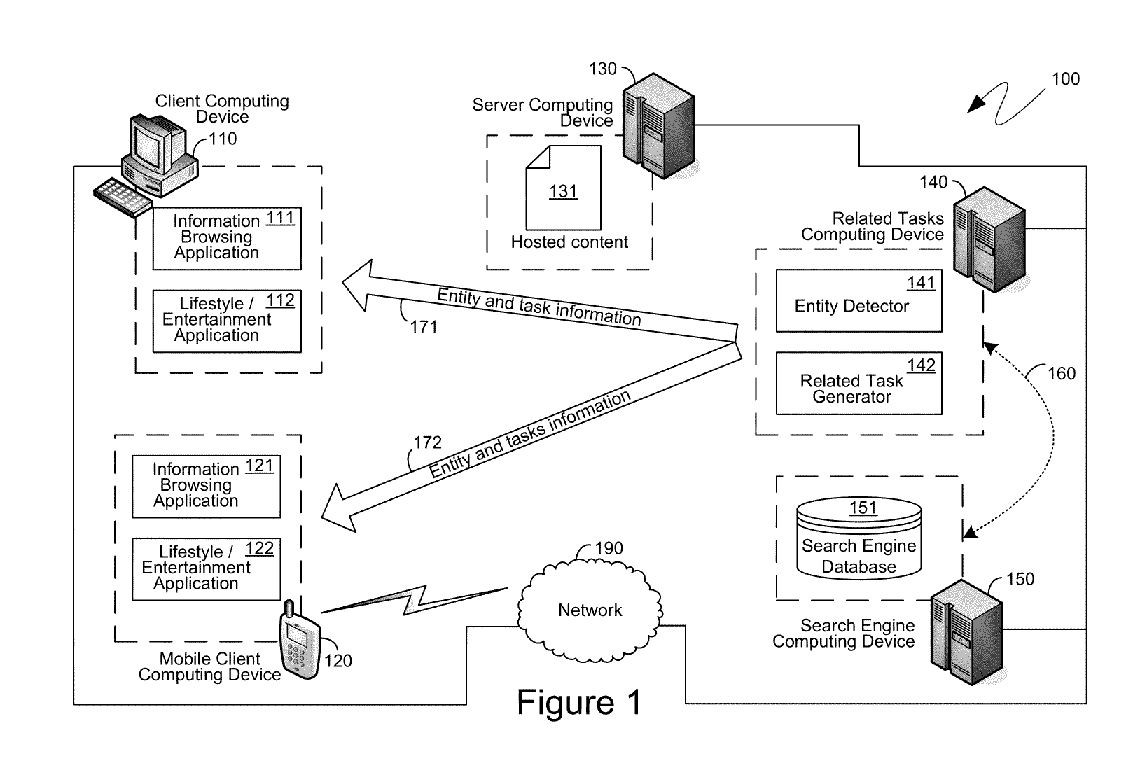

Turning to FIG. 1, an exemplary system 100 is shown, which provides context for the descriptions below. The exemplary system 100 of FIG. 1 is shown as comprising a traditional desktop client computing device 110, and a mobile client computing device 120 that are both communicationally coupled to a network 190. The network 190 also has, communicationally coupled to it, a server computing device 130, a related tasks computing device 140, and a search engine computing device 150. Although illustrated as separate, individual computing devices, the functionality described below with reference to the server computing device 130, the related tasks computing device 140 and the search engine computing device 150 could be performed by a single computing device or spread across many different physical, or virtual, computing devices. For example, in one embodiment, the functionality described below as being provided by the related tasks computing device 140 can be provided by the same computing device, or collection of computing devices, as the functionality described below as being provided by the search engine computing device 150.

Both the client computing device 110 and the mobile client computing device 120 are shown as comprising information browsing applications and lifestyle/entertainment applications to illustrate that the mechanisms described below are equally applicable to mobile computing devices, including laptop computing devices, tablet computing devices, smartphone computing devices, and other like mobile computing devices, as well as to the ubiquitous desktop computing devices. The client computing device 110 is shown as comprising an information browsing application 111 and the lifestyle/entertainment application 112. Similarly, the mobile client computing device 120 is illustrated as comprising an information browsing application 121 and a lifestyle/entertainment application 122. For purposes of the descriptions below, references to the information browsing application 111 executing on the client computing device 110 are intended to be equally applicable to the information browsing application 121 executing on the mobile client computing device 120, and vice versa. Similarly, for purposes of the descriptions below, references to the lifestyle/entertainment application 112 executing on the client computing device 110 are meant to be equally applicable to the lifestyle/entertainment application 122 executing on the mobile client computing device 120, and vice versa.

In one embodiment, the information browsing application 111, or the information browsing application 121, can be the ubiquitous web browser that can retrieve and display information in the form of websites that are hosted by web servers communicationally coupled to the network 190. However, as indicated previously, the mechanisms described below are not limited to World Wide Web-based environments. Thus, for example, information browsing applications, such as the information browsing applications 111 and 121, can be other types of information browsing applications including, for example, e-book readers, universal document format readers, or even content creation applications, such as word processors, spreadsheets, presentation applications, and e-mail applications.

Similarly, the descriptions below are equally applicable to lifestyle/entertainment applications, such as the lifestyle/entertainment application 112 executing on the client computing device 110 and the lifestyle/entertainment application 122 executing on the mobile client computing device 120. Lifestyle/entertainment applications can include applications for playing audio and video content, game applications, applications directed to controlling other electronic devices, such as digital video recorders, digital picture frames, and other like electronic devices, special-interest applications and other like applications.

In one embodiment, information browsing applications and lifestyle/entertainment applications can access information from other computing devices that are communicationally coupled to the network 190, such as, for example, the hosted content 131 that is provided by the server computing device 130. In one common example, the hosted content 131 can be a webpage of a website that is hosted by the server computing device 130. The information browsing applications 111 and 121 can, as indicated previously, be web browser applications, which can request the webpage and then, in accordance with the webpage content received from the server computing device 130, render such a webpage for display on the client computing device 110 and the mobile computing device 120, respectively. In another common example, the hosted content 131 can be an online “store” or other like digital construct, that can be accessed by an audio/video application, or other like lifestyle/entertainment application, to purchase audio and/or video content to be consumed by the user of a client computing device.

Although illustrated as such in the exemplary system 100 of FIG. 1, the information consumed by information browsing applications or lifestyle/entertainment applications need not be sourced from another computing device, such as the server computing device 130. Instead, such information can be locally available on one or more of the client computing devices, such as the client computing device 110 and the mobile client computing device 120. Irrespective of the source of the information being consumed by such information browsing applications and lifestyle/entertainment applications, such information can comprise references to “entities”, or can otherwise be associated with entities. An “entity”, as utilized herein, means any thing about which there is discrete, objective information available, such as can be determined by reference to a search engine database. By way of example, and not limitation, entities include individuals, organizations, places, products, activities, websites, entertainment offerings, and the like. As one specific example, the hosted content 131 can be a webpage of a shoe company that displays some of the shoes manufactured by that shoe company. In such an example, each of the shoes can be an entity since discrete, objective information can be found about each of the shoes, including, for example, their model or style numbers, their sizes, their prices at various merchants and the like. Similarly, as utilized herein, a “task” means an action that can be performed with respect to an entity. By way of example, and not limitation, tasks include purchasing, acquiring or renting an entity, making a reservation at an entity, accepting an offer from an entity, contacting an entity, such as by calling an entity or sending an electronic message to an entity, obtaining discrete information about an entity, such as comments about the entity from a social network or an entry about the entity in an online encyclopedic resource, posting information about an entity, or other like tasks.

In one embodiment, one or more search engine computing devices, such as the search engine computing device 150, can comprise a search engine database 151 that can comprise information collected from content that is accessible via the network 190, such as, for example, the hosted content 131 that is provided by the server computing device 130. Such a search engine database 151 can be referenced to identify entities. For example, as illustrated in the exemplary system 100 of FIG. 1, a related tasks computing device 140 can comprise an entity detector 141 that can utilize the search engine database 151 to identify entities. In addition, the search engine database 151 can be referenced to identify tasks related to those entities. For example, restaurant, hotel, rental car, airline, and other like entities can have reservation tasks associated with them since users can make reservations for or with such entities. As another example, music groups, comedians, athletes, and other like entities can have ticket purchasing tasks associated with them since users can purchase tickets to be entertained by such entities. Therefore, as illustrated by the exemplary system 100 of FIG. 1, the related tasks computing device 140 can also comprise related task generator 142, which can reference the search engine database 151 to identify tasks related to the entities identified by the entity detector 141. The utilization of the search engine database 151, by the entity detector 141 and the related task generator 142, is illustrated by the dashed arrow 160, signifying the relationship between them. While in one embodiment the entity detector 141 and the related task generator 142 can be separate processes executing on a computing device such as, for example, the related tasks computing device 140, in other embodiments they can be part of a single process, or each executed across multiple processes. Similarly, while in one embodiment, the entity detector 141 and the related tasks generator 142 can be executed on a computing device, such as the related tasks computing device 140, that is separate and apart from the search engine computing device 150, which can comprise the search engine database 151, in other embodiments the entity detector 141 and related task generator 142 can be executed on the same one or more computing devices comprising the search engine database 151.

The entity information obtained by the entity detector 141, and the tasks related to those entities that are identified by the related task generator 142, can be utilized to supplement the information presented to users by information browsing applications, lifestyle/entertainment applications and other application programs that present information to users. In one embodiment, the content being presented to a user can be provided to a server computing device such as, for example, the related tasks computing device 140, and such a server computing device can identify one or more entities within the content being presented to the user, or otherwise relevant to such content, and can communicate those entities, and tasks related to those entities, to the application presenting content to the user. In another embodiment, information regarding entities and related tasks can be obtained by the application presenting content to a user, such as by requesting such information from one or more server computing devices. The communications 171 and 172, illustrated in the exemplary system 100 of FIG. 1, are meant to illustrate the obtaining of entity and task information by one or more applications executing on client computing devices, such as the client computing device 110 and the mobile client computing device 120, whether such information is provided to such application programs in response to processing performed by one or more server computing devices, by the client computing devices, or by combinations thereof.

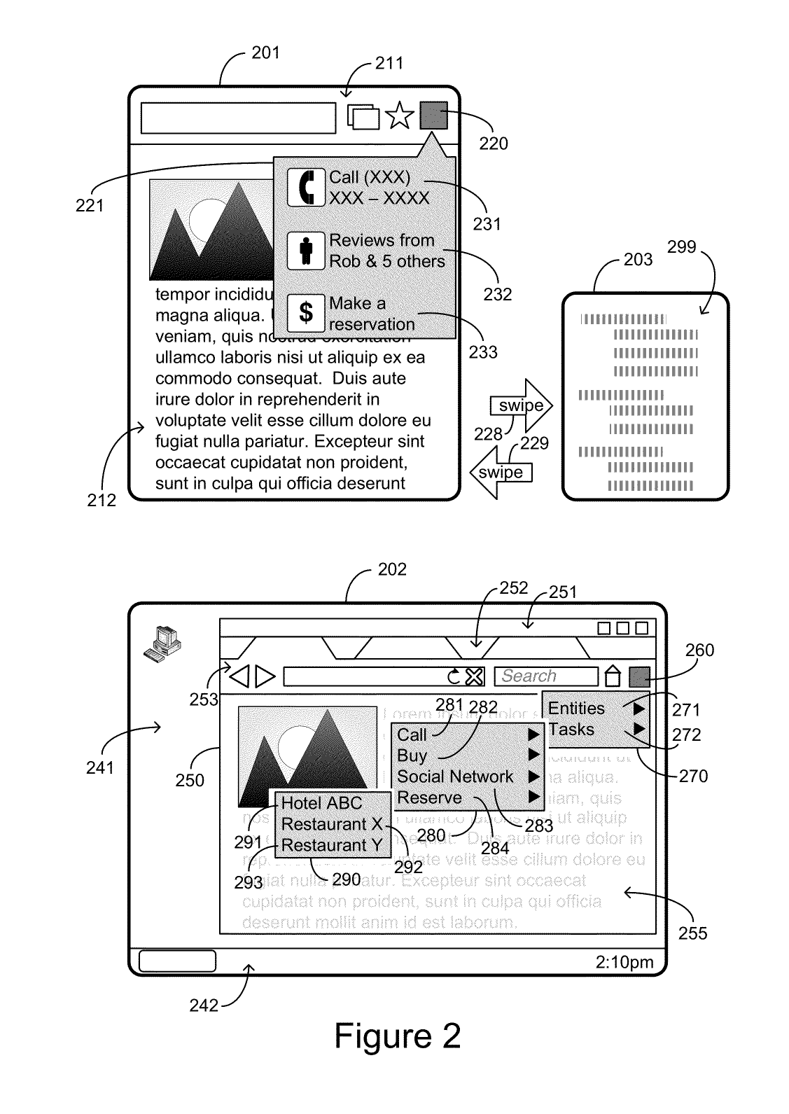

Turning to FIG. 2, user interfaces are shown, which illustrate exemplary manners by which entity and related task information can be presented to users. Exemplary user interface 201 illustrates a user interface that can be presented by a mobile computing device, such as a tablet computing device, a smartphone computing device, or other like mobile computing devices. The exemplary user interface 201 can be presented by an application executing on such a mobile computing device and having access to all, or substantially all, of the display area of such a mobile computing device's display. In one embodiment, user interface 201 can comprise a toolbar area 211 and a content presentation area 212. In the exemplary user interface 201, the content presentation area 212 is shown as presenting the content of a website, or other like multimedia document comprising textual content and graphical content. For purposes of the description below, the content being presented in the content presentation area 212 can be associated with one or more entities that can, in turn, be associated with one or more tasks. For example, the content being presented in the content presentation area 212 can directly reference one or more entities, or it can be contextually associated with one or more entities. For example, the content being presented in the content presentation area 212 can be sourced from the website of a particular entity. In such an example, even if the entity is not directly referenced in the content that is being presented, such content can be considered to be associated with such an entity. Thus, for example, a webpage showing a seat map of a particular airplane flown by a particular airline can be associated with that airline, as the entity, even if that airline is nowhere directly referenced on such a seat map webpage.

The entities and tasks associated with content can also be associated by virtue of the context in which such content is presented. For example, if the content being presented in the content presentation area 212 is a webpage, then it is likely that the user of the mobile computing device generating the exemplary user interface 201 visited a prior webpage from which the user was linked to the webpage currently being shown in the content presentation area 212. Such a browsing history, or listing of prior webpages visited by the user, can be part of a current user context. Thus, for example, if the content being presented in the content presentation area 212 is a webpage describing a mattress, and the current user context indicates that the user had, immediately previously, browsed a series of webpages describing a particular hotel, and was directed to the mattress webpage by one of the hotel webpages, such as, for example, a webpage listing that brand of mattress as an attribute of the rooms of the hotel, then, in such a context, the hotel, as an entity, can be associated with the mattress webpage while, in other user contexts, the hotel would not be associated with the mattress webpage.

In one embodiment, to present entities and tasks to a user, the exemplary user interface 201 can comprise a user interface element 220 to which the user can direct action, such as a selection action, a hover action, or other like user action, in order to invoke the presentation of entities and tasks. For example, within the exemplary user interface 201, if the user were to direct user action to the user interface element 220, a drop-down menu 221, or other like user interface element, can be presented which can list entities, tasks, or combinations thereof. In the specific context of a mobile computing device, user action directed to the user interface element 220 can be a tap or other like touch-based user interface action.

As will be recognized by those skilled in the art, mobile computing devices such as, for example, tablet computing devices and smartphone computing devices, often comprise smaller display areas than the ubiquitous desktop computing device and, due to the nature of their use, it is often desirable to avoid clutter within such smaller display areas and to present information within such smaller display areas in a limited manner such that the user can quickly consume such presented information. Thus, as an example, the drop-down menu 221 of the exemplary user interface 201 comprises only a few tasks associated with entities that were deemed to be associated with the user context, which can include the content that is being presented in the content presentation area 212. One such task is the exemplary call task 231 by which a user can utilize the mobile computing device to call a phone number that is associated with an entity that was deemed to be associated with the user context. For example, returning to the above example of a hotel webpage, if the content being presented in the content presentation area 212 is a webpage of a hotel, than the call task 231 can enable the user to call that hotel by selecting such a task. More specifically, in such an example, the hotel, as an entity, can have been identified to be associated with the hotel webpage being presented in the content presentation area 212, and such a hotel entity can have had one or more tasks associated with it such as, for example, a task directed to calling the phone number associated with such a hotel entity. Additional information can have indicated that the hotel entity was the most significant, or one of the most significant, entities associated with the user context, and, with respect to the hotel entity, the call task was the most significant, or one of the most significant, tasks associated with such an entity. Consequently, exemplary user interface 201 can, in such an example, present the call task 231 as the foremost, or topmost, task presented in the drop-down menu 221.

Another example of a task that can be associated with an entity can be a social networking task, such as the social networking task 232, that can enable a user to obtain information regarding the entity from individuals that the user trusts, or with which the user is otherwise connected such as, for example, individuals to which the user is connected via one or more social networking services. Thus, in the exemplary user interface 201, the drop-down menu 221 can include the social networking task 232 that the user can select to read, for example, reviews or comments from individuals deemed to be associated with such user. In one example, at least one individual, such as the individual named “Rob” in the example illustrated in FIG. 2, can be specifically named or called out in the social networking task 232. Additionally, as another example, the quantity of individuals or other social networking constructs to which the social networking task 232 can be directed can be specifically enumerated to enable the user to determine whether it is worth their while to select such a social networking task 232. Thus, in the example illustrated in FIG. 2, the social networking task 232 identifies that there are five other individuals from whom the user could receive reviews, if the user selects the social networking task 232.

The drop-down menu 221 can include as many tasks as can be meaningfully conveyed to the user without burdening the user. Thus, for example, the drop-down menu 221 illustrated in FIG. 2 is shown as comprising three tasks, namely the call task 231, the social networking task 232 and a make reservation task 233. The make reservation task 233 can be analogous to the call task 231. In particular, returning to the above example where an entity associated with the content being presented in the content presentation area 212 is a hotel entity, the make reservation task 233 can enable the user to make a reservation at that hotel such as, for example, by directly accessing a reservation webpage for such a hotel. In other examples, the drop-down menu 221 can comprise a greater or fewer number of tasks, depending on the size of the display on which the drop-down menu 221 is being displayed, the size of the font utilized, the orientation of the display, and other like factors.

In another embodiment, as a greater amount of space is available within which to display information, a hierarchical approach can be utilized. For example, the exemplary user interface 202 illustrates a user interface that can be presented by a desktop computing device, a laptop computing device, or other like personal computing device. As will be recognized by those skilled in the art, the exemplary user interface 202 can comprise a taskbar area 242 and a desktop area 241 on which can be displayed one or more “windows”, or other like, self-contained user interface structures, such as the window 250. The window 250 can comprise a window control area 251 through which aspect and attributes of the window can be controlled, although such is orthogonal to the mechanisms described herein and is illustrated only for the sake of providing visual context. The application rendering the content within the window 250 can be an application capable of utilizing a tab motif to enable a user to more easily navigate between different content and, as such, is shown as comprising a tab area 252. Like the window control area 251, the tab area 252 is orthogonal to the mechanisms described herein and is illustrated only for the sake of providing visual context. Like the toolbar area 211 of the exemplary user interface 201, the exemplary user interface 202 can comprise a corresponding toolbar area 253 that can reflect the greater visual space allotted for the presentation of such a toolbar. Additionally, the window 250 can comprise a content presentation area 255, which is exemplarily shown in FIG. 2 as presenting textual and graphical content.

The toolbar area 253 can comprise a user interface element 260 that can be analogous to the user interface element 220 described in detail above. In particular, the user interface element 260 can, like the user interface element 220, provide the user with information regarding entities and related tasks when the user directs user action to the user interface element 260. User action directed to the user interface element 260 can be a hover action, whereby the user positions a graphical cursor over the user interface element 260 for an extended period of time, a selection action, whereby the user depresses a mouse button, presses on a trackpad, or performs another action signifying a selection user action, a double-click user action, or other like user actions.

In one embodiment, unlike the drop-down menu 221, which can be simplified and more limited due to the constraints and usage scenarios of the computing device on which it is presented, the drop-down menus presented in response to user action directed to the user interface element 260 can present a greater amount of information including, for example, presenting it in a hierarchical format such that selections in one drop-down menu result in the presentation of a subsequent drop-down menu. For example, as shown in FIG. 2, user action directed to the user interface element 260 can result in the presentation of the drop-down menu 270. In one embodiment, the drop-down menu 270 can comprise an entities selection 271 and a tasks selection 272. Subsequent user action directed to the entities selection 271 can result in a subsequent drop-down menu that can display further information about one or more entities deemed to be associated with the user context, such as, for example, a listing of such entities. Similarly, subsequent user action directed to the tasks selection 272 can result in a subsequent drop-down menu 280, which can comprise a listing of tasks associated with the entities that were deemed to be associated with the user context. For example, the drop-down menu 280 can comprise a call task 281, a buy task 282, a social networking task 283 and a reserve task 284. Returning to the prior example where the content being presented in the content information area 255 is content about a hotel, the call task 281 can be analogous to the call task 231 described above. Similarly, the social networking task 283 can be analogous to the social networking task 232 described above. Because of the hierarchical nature the drop-down menus illustrated in the exemplary user interface 202, the amount of information contained in any one drop-down menu can be more limited, since a user interested in such information can be presented with a further, hierarchical drop-down menu when the user selects such information. Thus, for example, while the social networking task 232 was illustrated in the drop-down menu 221 as including information regarding at least one specific individual and an aggregate quantity of individuals from whom information could be obtained, such information could be presented in the exemplary user interface 202 in a further drop-down menu that could be displayed when the user selected the social networking task 283. More specifically, continuing such an example, user selection of the social networking task 283 could result in a further, subsequent drop-down menu from which the user could select specific, individual users' reviews.

As indicated previously, in one embodiment, multiple entities can be determined to be associated with a user context, which, as also indicated previously, can include the content currently being presented in a content presentation there, such as the content presentation area 255. Consequently, the tasks presented in the drop-down menu 280, which is presented as a result of user action directed to the tasks selection 272 in the drop-down menu 270, can be tasks that are associated with multiple different entities. Thus, among the exemplary tasks shown in the drop-down menu 280 of FIG. 2, the reserve task 284 can be directed to a different entity than the buy task 282. For example, returning to the above example where the content being presented in the content presentation area 255 is information about a mattress, which is being presented because the user was directed to such content from a hotel webpage listing such a mattress as a benefit of the hotel, it can be determined that both the hotel, as an entity, and the mattress, as an entity, are associated with the current user context. As such, the buy task 282 can be directed to the mattress entity, thereby enabling the user to purchase such a mattress, while the reserve task 284 can be directed to the hotel entity, enabling a user to reserve a room at the hotel.

Another mechanism by which, in one embodiment, the entities with which tasks are associated can be identified is through another, subsequent, hierarchical drop-down menu. For example, the drop-down menu 280 that is shown in exemplary interface 202 can include a reserve task 284 that can be applicable to multiple entities such as, for example, a hotel entity 291 and restaurant entities 292 and 293 that can, for example, be restaurants within that hotel. Thus, in one embodiment, a user action directed to the reserve task 284 in the drop-down menu 280 can result in a further, hierarchical drop-down menu 290 that can present the entities 291, 292 and 293, and enable the user to select which entity they wish to make a reservation with. Other, similar hierarchical drop-down menus can be presented to the user upon selection of one or more of the call task 281, the buy task 282 or the social network task 283.

In another embodiment, additional entity and task information, such as in a hierarchical structure, can be presented in a separate user interface context. Returning to the exemplary user interface 201, as indicated, such exemplary user interface can be displayed on a mobile computing device, such as a tablet computing device or a smartphone computing device. As will be recognized by those skilled in the art, such mobile computing devices often rely upon touch input, and can often accept “multi-touch” input, whereby the user provides input by simultaneously pressing two or more of their fingers down upon a touch sensitive surface and performing an action, such as bringing their fingers closer together, spreading their fingers further apart, or sliding their fingers in a particular direction. Thus, as an example, if a user were to apply a multitouch gesture to the exemplary user interface 201, such as, for example, a swipe gesture 228, whereby the user slides two or more fingers simultaneously in a left or right direction, a different user interface context, such as the exemplary user interface 203 can be presented. In such an embodiment, the user interface 203 can replace the user interface 201, as a result of the swipe gesture 228, and can display, in the hierarchical format 299, information regarding entities and tasks that are found to be associated with the user context that includes the content being presented in the content presentation area 212. Optionally, another gesture, such as the swipe gesture 229 in an opposite direction as the swipe gesture 228 can cause the exemplary user interface 201 to be returned, and exemplary user interface 203 to no longer be displayed. In such a manner, a greater amount of entity and task information can be displayed than could otherwise be displayed in, for example, the drop-down menu 221.

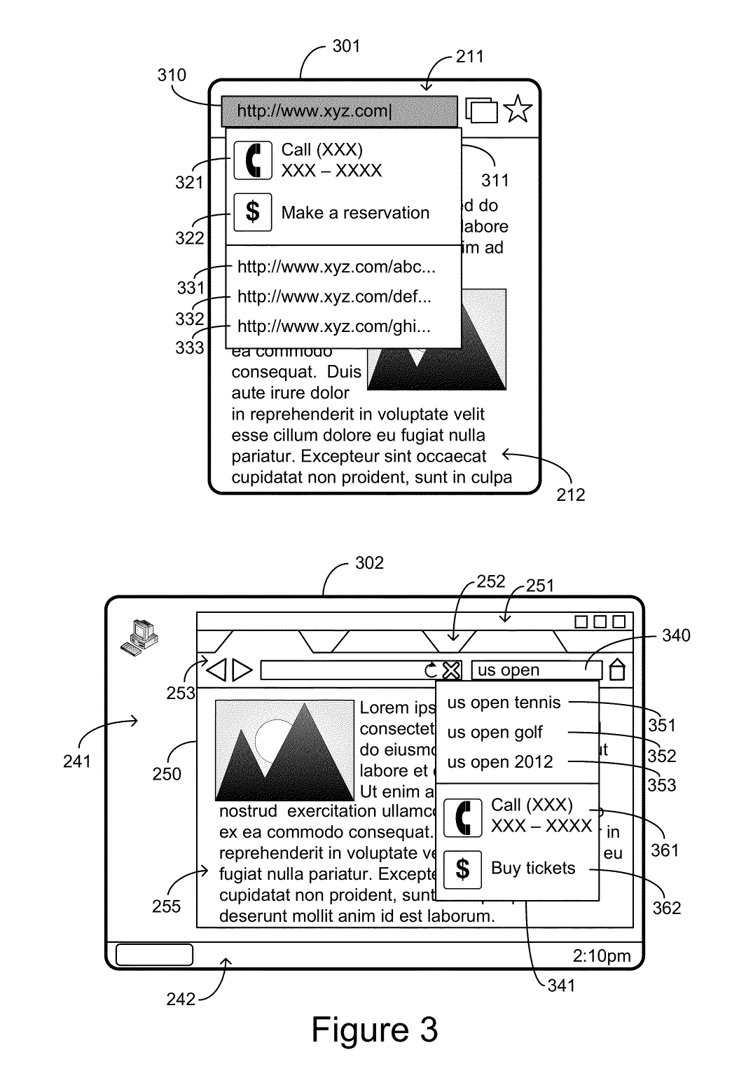

Turning to FIG. 3, the exemplary user interfaces 301 and 302 shown therein illustrate exemplary user interfaces contemplated by another embodiment, wherein the user context upon which entities and tasks are selected can include information about content to be presented to the user in the future. More specifically, a user can select content to be presented through a variety of mechanisms including, for example, through textual entry mechanisms wherein the user enters textual information that can be utilized to identify, locate and retrieve content for presentation to the user. For example, within the specific context of the ubiquitous web browser, a user can direct such a web browser to retrieve and display webpages by typing in a Uniform Resource Locator (URL), or other like identifier for a webpage, by typing in one or more search terms that can be utilized to search for a webpage, or by generating other like textual entries. As will be recognized by those skilled in the art, in certain instances the user can be aided in the entry of textual information, such as the entry of a URL, or the entry of search terms, based upon likely URLs or search terms that the user may be entering. For example, the URLs visited by the user in the past can be utilized such that, if, as an example, the user had previously visited the URL www.someplace.com, and the user was now entering the text “www.som”, the URL www.someplace.com could be offered to the user as a suggestion, such that the user need not finish entering all of the textual characters of such a URL, and could, instead, simply select such a suggestion, thereby rendering the process of entering such a URL more efficient. Similarly, as another example, and as will also be recognized by those skilled in the art, existing databases, such as the search engine database described in detail above, can be referenced to aid the user in entering search terms by suggesting search terms that are similar to the characters already entered by a user, and about which the search engine database has already collected information. Thus, as another example, if the user were to begin to search for the terms “us open”, reference to the search engine database could reveal that the search engine database comprises information regarding the U.S. Open tennis tournament, the U.S. Open golf tournament, and the like and, consequently, upon entry of the terms “us open”, the suggestions “us open tennis” and “us open golf” could be provided to the user such that the user need not complete entry of all the characters of such search terms and could, instead, simply select from one of the suggestions, thereby rendering the process of entering search terms more efficient.

In one embodiment, such existing mechanisms for providing the user with suggestions or for pre-filling in information for the user can be leveraged to also provide to the user information regarding entities and tasks that are associated with the user context. For example, as illustrated in the exemplary user interface 301, the previously described toolbar area 211 can comprise a resource locator area 310 in which the user can enter information to direct the application to the subsequent set of content that the user desires to have displayed to them in the content presentation area 212. Additionally, and as also illustrated in FIG. 3, the user can have begun entering textual information into the resource locator area 310 such as, for example, a URL of a webpage that the user desires to have displayed within the content presentation area 212. In one embodiment, if entities or tasks are found to be associated with such a user context, which can include, not only the content currently being displayed in the content presentation area 212, but also the content that is likely being requested by the user via the textual entry that the user is making in the textual entry and display area 310, then the resource locator area 310 can inform the user of such associated entities or tasks. For example, the resource locator area 310 can change colors or can otherwise visually indicate to the user that additional information is available via the textual entry and display area 310. Thus, in the exemplary user interface 301 that is shown in FIG. 3, the resource locator area 310 is shown as having changed to a gray background from a white background. User selection, or other user action directed to the textual entry and display area 310, can cause the drop-down menu 311 to appear, which can, in such an embodiment, include not only suggestions, such as the suggestions 331, 332 and 333, which can be based on the input provided by the user in the textual input and display area 310, but can also include entities or tasks, such as the call task 321 or the reservation task 322 that can be relevant to the user context, which, as indicated previously, can include the input provided by the user in the textual input and display area 310.

To provide a specific example for purposes of further enumerating the embodiments illustrated by the exemplary user interface 301, if the user had entered a URL of a restaurant's website in the resource locator area 310, the drop-down menu 311 can include suggestions for specific webpages of that restaurant, such as webpages that might comprise a menu of the restaurant, its location and hours, or a background of its chef. Such specific webpages can be suggested in a traditional manner in the drop-down menu 311, and are represented by the suggestions 331, 332 and 333 that are illustrated in the exemplary user interface 301, shown in FIG. 3. Such a restaurant, however, can also be an entity that can have tasks associated with it. One such task can be the call task 321, which enable a user to call the restaurant without having to search for the phone number of the restaurant in one of the webpages, and then manually enter it into a phone application. Another task can be a reservation task 322, which can enable the user to make reservations at the restaurant without having to search for a specific reservation page or other like reservation taking mechanism. When it is determined that entities or tasks are associated with the user context, the resource locator area 310 can provide a visual cue to the user, such as by changing colors, such as in the manner illustrated in FIG. 3. User action directed to the resource locator area 310 can then result in the presentation of the drop-down menu 311, which can comprise the suggestions 331, 332 and 333, and also related tasks or entities, such as the call task 321 and the reservation task 322.

In the illustrative example provided, the content being presented in the content presentation area 212 need not necessarily be associated with the restaurant and can be simply another webpage that the user was browsing. As can be seen, therefore, the user context upon which a determination of associated tasks and entities can be based can include not only content that the user is currently being presented, or has previously been presented, but can also include content that is yet to be presented to the user but that is predicted to be presented to the user based upon user entry, such as textual entry in the resource locator area 310.

In another embodiment, rather than being presented within the context of a resource locator area 310, associated entities and tasks can be provided to the user within the context of a search area 340 through which a user can enter search terms and access search functionality. More specifically, the exemplary user interface 302 comprises a window 250 that can include the search area 340. A user utilizing the search area 340 to enter search terms can be presented with suggestions, such as the suggestions 351, 352 and 353, that can represent commonly utilized search terms, or search terms for which there exists a well-defined set of results in a search engine database. The mechanism by which the user is presented with such suggestions can also be utilized to present the user with entities or tasks associated with the user context which can include, as indicated previously, the search terms being entered into the search area 340 and the associated content that would be identified, by the search engine, in response to those search terms. For example, as illustrated by the exemplary user interface 302, a user utilizing the search area 340 to enter search terms that start with the terms “us open” may be searching for the U.S. Open tennis tournament, the U.S. Open golf tournament, or other like information and, consequently, the user can be presented with a drop-down menu 341 that can comprise suggested search terms such as the “us open tennis” suggestion 351, the “us open golf” suggestion 352, and the “us open 2012” suggestion 353. Such a drop-down menu 341 can also comprise entities or tasks that are deemed to be associated with the user context such as, for example, a call task 361 or a buy tickets task 362.

As indicated previously, the user context can include information provided by the user regarding content for which the user is searching or requesting. In another embodiment, the user context can also include the context within which such a search is taking place including, for example, the date and time when such a search is taking place, the location from which the user is performing such a search and the like. Thus, illustratively, in the specific example shown in the exemplary user interface 302, there may exist an ambiguity as to whether the user's entry of the terms “us open” in the search area 340 refers to the US Open tennis tournament or the U.S. Open golf tournament. Other information from the user context can be utilized to resolve such ambiguity. For example, the user may be entering the terms “us open” in the search area 340 during the period of time when only the U.S. Open tennis tournament is actively ongoing. Or, as another example, the user may be entering the terms “us open” in the search area 340 from a location that is proximate to the location of the U.S. Open tennis tournament. In such examples, such other information from the user context can be utilized to determine that the US Open tennis tournament, as an entity, is associated with the user context and that the US Open tennis tournament, as an entity, has tasks associated with it, such as the call task 361, or the buy tickets task 362. Such tasks can be presented to the user via the same drop-down menu 341, emanating from the search area 340, as the suggestion 351, 352 and 353.

Although not specifically illustrated in FIG. 3, the above-described separate user interface context can also be applicable to the exemplary user interfaces of FIG. 3. For example, the exemplary user interface 301 can be analogous to the exemplary user interface 201, described in detail above, in that a swipe, or other like user action, can cause the presentation of a separate user interface context, such as the exemplary user interface 203, which was also described in detail above. As indicated, the exemplary user interface 203 can comprise further entity and/or task information than would be presented in, for example, the user interface 301. As such, a user desiring such additional information can perform a swipe action, or other like user action, to transition between the exemplary user interface 301 and the exemplary user interface 203.

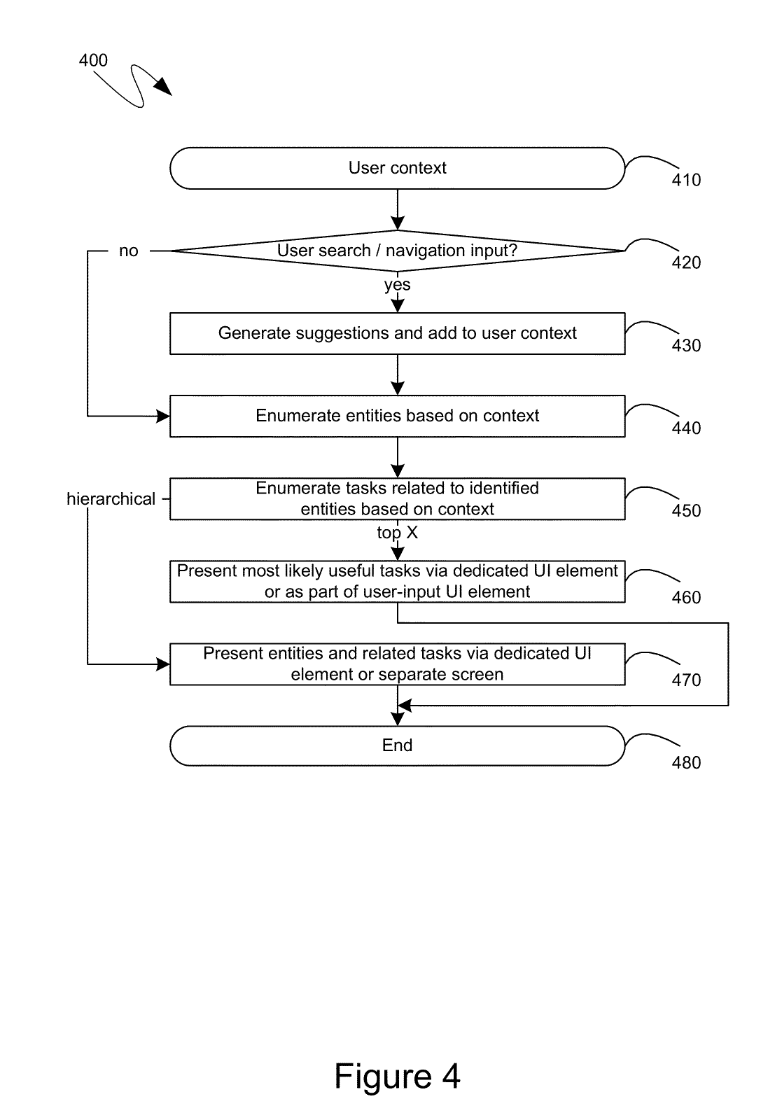

Turning to FIG. 4, the flow diagram 400 shown therein illustrates an exemplary series of steps by which the exemplary user interfaces described in detail above can be generated and presented to a user. Initially, at step 410, processing can commence with a user context. As indicated previously, a user context can comprise information regarding content that was previously presented to the user, content that is currently being presented to the user, a current date, a current location of the user, any information that may already be known about the user by services for which the user has registered and which can be in communication with the currently described mechanisms, and any other like information. Subsequently, at step 420, a determination can be made as to whether there is any user input in the form of search terms, URLs, or other like input evidencing a user intent to obtain further content for presentation to the user. If, at step 420, it is determined that such user input has been received, then, at step 430, suggestions based on such received user input can be generated and added to the user context and processing can proceed with step 440. Alternatively, if, at step 420, it is determined that no such user input has been received, then processing can proceed directly to step 440.

At step 440, entities based on the user context can be enumerated. In one embodiment, such an enumeration of entities can be performed by one or more processes executing on one or more server computing devices that can have access to relevant information such as, for example, the search engine database described above. For example, the user context can be provided, by client computing device, to one or more server computing devices, and processes executing on those computing devices can utilize such context to determine whether there are any entities associated with such context such as, for example, by searching for key terms, concepts, identifiers, or other like indicia of one or more entities. In another embodiment, such an enumeration of entities can be performed by processes executing on both the client computing device presenting the user interface and on one or more server computing devices. For example, at least a portion of the user context can be provided to server computing devices, and an initial set of other entities can be received from such server computing devices, which can then, subsequently, be further refined by processes executing on the client computing device presenting the user interface.

Subsequently, at step 450, tasks associated with the entities that were identified at step 440 can be identified. In one embodiment such tasks can be identified with reference to the user context while, in other embodiments, all of the tasks associated with an entity can be enumerated. If the entity and task information is being presented to the user via a hierarchical structure such that multiple entities and their associated tasks can be presented simultaneously, processing can proceed with step 470. Conversely, if the entity and task information is being presented to the user that has a more limited user interface, a filtering process can be applied and processing can proceed with step 460. More specifically, in one embodiment, after the enumeration of entities and tasks, at steps 440 and 450, that are associated with the user context, all of such enumerated entities and tasks can be presented to the user via a hierarchical structure such that the user, by virtue of the hierarchical structure of the presentation, can direct their attention to only those entities, or only those tasks that may be relevant or meaningful to the user. Consequently, as illustrated, processing can proceed to step 470 where a collection of tasks and entities can be presented to the user in a hierarchical manner through, for example, dedicated user interface elements or wholly separate user interface contexts such as, for example, the separate screen of information that can be presented to the user, such as in the manner described in detail above. In another embodiment, however, after the enumeration of entities and tasks, at steps 440 and 450, a further filtering can be performed to select only the most relevant entities and/or tasks for presentation to the user. Such a filtering can be performed by processes executing on the client computing device that is presenting the user interface, by processes executing on one or more server computing devices, or by processes executing on both the client computing device and one or more server computing devices, acting in concert. Once such filtering is performed, processing can proceed with step 460 where such a selected set of entities, tasks or combinations thereof can be presented to the user, either via a dedicated user interface element, or as part of existing user interface elements through which users direct input, such as search input, resource location input, and other like input. The relevant processing can then end at step 480, as shown.

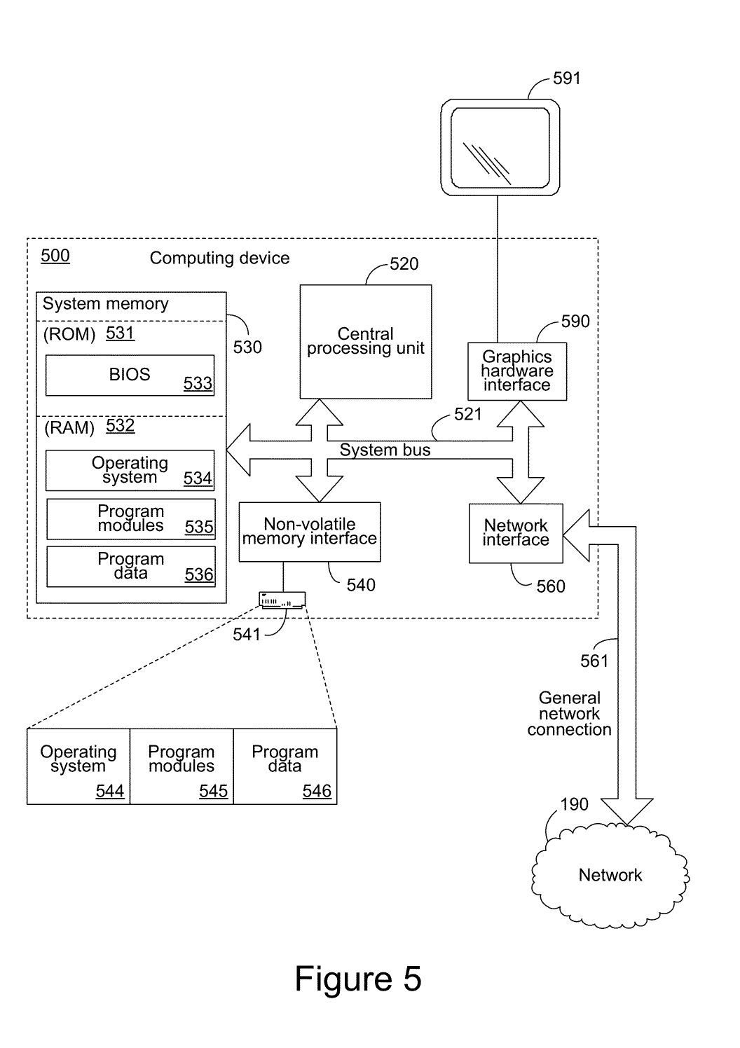

Turning to FIG. 5, an exemplary computing device 500 is illustrated. The exemplary computing device 500 can be any one or more of the client computing device 110 and the server computing devices 120 and 130 illustrated in the previously referenced Figures, whose operations were described in detail above. Similarly, the exemplary computing device 500 can be a computing device that can be executing one or more processes that can represent the client computing device 110 and the server computing devices 120 and 130 illustrated in the previously referenced Figures, such as, for example, by executing one or more processes that create virtual computing environments that can provide for the operations detailed above in connection with the client computing device 110 and the server computing devices 120 and 130. The exemplary computing device 500 of FIG. 5 can include, but is not limited to, one or more central processing units (CPUs) 520, a system memory 530, that can include RAM 532, and a system bus 521 that couples various system components including the system memory to the processing unit 520. The system bus 521 may be any of several types of bus structures including a memory bus or memory controller, a peripheral bus, and a local bus using any of a variety of bus architectures. The computing device 500 can optionally include graphics hardware, such as for the display of visual user interfaces, including, but not limited to, a graphics hardware interface 590 and a display device 591. Depending on the specific physical implementation, one or more of the CPUs 520, the system memory 530 and other components of the computing device 500 can be physically co-located, such as on a single chip. In such a case, some or all of the system bus 521 can be nothing more than silicon pathways within a single chip structure and its illustration in FIG. 5 can be nothing more than notational convenience for the purpose of illustration.

The computing device 500 also typically includes computer readable media, which can include any available media that can be accessed by computing device 500 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and the aforementioned RAM 532. A basic input/output system 533 (BIOS), containing the basic routines that help to transfer information between elements within computing device 500, such as during start-up, is typically stored in ROM 531. RAM 532 typically contains data and/or program modules that are immediately accessible to and/or presently being operated on by processing unit 520. By way of example, and not limitation, FIG. 5 illustrates the operating system 534 along with other program modules 535, and program data 536.

The computing device 500 may also include other removable/non-removable, volatile/nonvolatile computer storage media. By way of example only, FIG. 5 illustrates the hard disk drive 541 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. Note that these components can either be the same as or different from operating system 534, other program modules 535 and program data 536. Operating system 544, other program modules 545 and program data 546 are given different numbers hereto illustrate that, at a minimum, they are different copies.

The computing device 500 can operate in a networked environment using logical connections to one or more remote computers. The computing device 500 is illustrated as being connected to the general network connection 561 through a network interface or adapter 560 which is, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 561. It will be appreciated that the network connections shown are exemplary and other means of establishing a communications link between computing devices may be used.

As can be seen from the above descriptions, mechanisms and user interfaces for providing related tasks for identified entities have been enumerated. In view of the many possible variations of the subject matter described herein, we claim as our invention all such embodiments as may come within the scope of the following claims and equivalents thereto.

We claim:

1. One or more computer-readable media comprising computer-executable instructions for providing user access to tasks and entities that are associated with a current user context, the computer-executable instructions performing steps comprising:
receiving user input indicative of subsequent content requested by a user, the user input being provided via a first user input area;
updating the current user context, comprising content currently being presented to the user, to further comprise the received user input;
generating a notification in the first user input area indicating an availability of one or more tasks directed to one or more entities that are associated with the updated user context; and
generating a presentation of at least some of the one or more tasks, proximate to the first user input area, if a user action is directed towards the generated notification, the generated presentation comprising at least one of: a purchase task directed to purchasing an entity, a reservation task directed to making a reservation at the entity, and a contact task directed to contacting the entity.

2. The computer-readable media of claim 1, wherein the computer-executable instructions for generating the notification comprise computer-executable instructions for changing a color of the first user input area.

3. The computer-readable media of claim 1, wherein the computer-executable instructions for generating the presentation comprise computer-executable instructions for generating the presentation of the at least some of the one or more tasks within a drop-down menu emanating from the first user input area.

4. The computer-readable media of claim 3, wherein the drop-down menu further comprises at least one of: suggested search terms based on the received user input or suggested uniform resource locators based on the received user input.

5. The computer-readable media of claim 1, wherein the first user input area is a search area of a browser application or a resource locator area of the browser application.

6. The computer-readable media of claim 1, comprising further computer-executable instructions for: receiving a multitouch user input; and, in response to the received multitouch user input, generating a different user interface comprising presentation of at least some of the one or more entities and additional ones of the one more tasks in a hierarchical format.

7. The computer-readable media of claim 1, wherein the updated user context further comprises content previously presented to the user.

8. A graphical user interface, generated on a display device by a computing device, providing access to tasks and entities that are associated with a current user context, the user interface comprising:
a first user input area for receiving user input indicative of subsequent content requested by a user;
a notification in the first user input area indicating an availability of one or more tasks directed to one or more entities that are associated with an updated user context comprising both a content currently being presented to the user and the received user input; and
a first user interface element, proximate to the first user input area, the first user interface element comprising a presentation of at least one of: a purchase task directed to purchasing an entity, a reservation task directed to making a reservation at the entity, and a contact task directed to contacting the entity.

9. The graphical user interface of claim 8, wherein the notification in the first user input area comprises a change in a color of the first user input area.

10. The graphical user interface of claim 8, wherein the first user interface element comprises a drop-down menu emanating from the first user input area.

11. The graphical user interface of claim 10, wherein the first user interface element further comprises at least one of: suggested search terms based on the received user input or suggested uniform resource locators based on the received user input.

12. The graphical user interface of claim 8, wherein the first user input area is a search area of a browser application or a resource locator area of the browser application.

13. The graphical user interface of claim 8 further comprising a hierarchical format presentation of at least some of the one or more entities and additional ones of the one more tasks, which is presented in a separate user interface context in response to a multitouch user input gesture.

14. The graphical user interface of claim 8, wherein the updated user context further comprises content previously presented to the user.

15. A graphical user interface, generated on a display device by a computing device, providing access to tasks and entities that are associated with a current user context, the user interface comprising:
content being presented to a user;
a first user interface element outside of a content presentation area where the content is being presented to the user; and
a second user interface element, proximate to the first user interface element, the second user interface element comprising a presentation of at least one of: a purchase task directed to purchasing an entity, a reservation task directed to making a reservation at the entity, and a contact task directed to contacting the entity.

16. The graphical user interface of claim 15, wherein the second user interface element obscures at least a portion of the content being presented to the user.

17. The graphical user interface of claim 15, wherein the second user interface element comprises a drop-down menu emanating from the first user interface element.

18. The graphical user interface of claim 17, wherein the drop-down menu is one of a hierarchical series of drop-down menus.

19. The graphical user interface of claim 15, wherein the first user interface element is an icon in a toolbar of an application presenting the content.

20. The graphical user interface of claim 15, further comprising a hierarchical format presentation of at least some of the one or more entities and additional ones of the one more tasks, which is presented in a separate user interface context in response to a multitouch user input gesture.
